(19) United States
(12) Patent Application Publication
(10) Pub. No.: US 2024/0310563 A1
(43) Pub. Date: Sep. 19, 2024

(54) VIEW BLIND CHECK FILM, IMAGE DISPLAY APPARATUS, AND VIEW BLIND CHECK METHOD

(71) Applicant: NITTO DENKO CORPORATION, Osaka (JP)

(72) Inventors: Saori Yamamoto, Osaka (JP); Yuji Toyota, Osaka (JP)

(73) Assignee: NITTO DENKO CORPORATION, Osaka (JP)

(21) Appl. No.: 18/597,047

(22) Filed: Mar. 6, 2024

(30) Foreign Application Priority Data
Mar. 17, 2023 (JP) 2023-043458

(51) Int. Cl. G02B 5/30; G02B 5/08

(52) U.S. Cl. CPC G02B 5/3041

(57) ABSTRACT

There is provided a view blind check film that allows whether or not an image display apparatus is blinded to easily be checked inside a space for which an anti-peeping system is employed. A view blind check film according to at least one embodiment of the present invention includes: a polarizing plate including a polarizer; and a reflective layer arranged on at least a part of one of principal surfaces of the polarizing plate.

### BACKGROUND OF THE INVENTION

This application claims priority under 35 U.S.C. Section 119 to Japanese Patent Application No. 2023-043458 filed on Mar. 17, 2023 which is herein incorporated by reference.

### 1. Field of the Invention

The present invention relates to a view blind check film, an image display apparatus, and a view blind check method.

### 2. Description of the Related Art

Use of an open meeting room that offers a feeling of spatial openness has been widely spread. For example, a large number of meeting rooms having a transparent wall or partition formed of a glass plate or an acrylic plate to produce a feeling of openness have been designed and constructed. In many cases, a large monitor used as a display device for presentation is installed in a meeting room. Further, a laptop personal computer (PC) or a tablet computer, which is used by a meeting participant, is brought into the meeting room. The meeting room as described above offers a feeling of openness. Meanwhile, in some cases, there arises a problem in that information displayed on, for example, the large monitor installed in the meeting room or the laptop PC brought into the meeting room may be peeped by a third party.

In order to solve the problem as described above, there has been proposed an anti-peeping system in which a polarizing film is bonded to a transparent wall or partition of the meeting room to conceal information displayed on the large monitor so that the information is invisible from an outside of the meeting room while keeping a feeling of openness (see, for example, KUROGANE KOSAKUSHO LTD., General Catalog [2020 Edition, Vol. 45, p. 110]). In such an anti-peeping system, the polarizing film is typically bonded to the transparent wall or partition of the meeting room so that an absorption axis of the polarizing film is perpendicular to an absorption axis of a viewer side polarizing plate of the large monitor installed in the meeting room. However, it is impossible to know whether or not an absorption axis of a viewer side polarizing plate of, for example, a laptop PC brought into the meeting room is perpendicular to the absorption axis of the polarizing film. Thus, a meeting participant may feel anxious about whether or not a display screen of, for example, the laptop PC is blinded. Thus, the meeting participant is required to go outside the meeting room so as to check whether or not the display screen is blinded. Further, an absorption-axis direction of the polarizing film may vary in accordance with an absorption-axis direction of the viewer side polarizing plate of, for example, the large monitor. Thus, a similar problem may arise when the absorption-axis direction varies.

### SUMMARY OF THE INVENTION

The present invention has been made to solve the conventional problems described above, and has a primary object to provide a view blind check film that allows whether or not an image display apparatus is blinded to easily be checked inside a space for which an anti-peeping system is employed.
[1] According to at least one embodiment of the present invention, there is provided a view blind check film including: a polarizing plate including a polarizer; and a reflective layer arranged on at least a part of one of principal surfaces of the polarizing plate.
[2] In the above-mentioned item [1], the reflective layer has a total light reflectance of 80.0% or more.
[3] In the above-mentioned item [1] or [2], the reflective layer is a metal layer.
[4] In the above-mentioned item [1] or [2], the reflective layer is a white layer.
[5] In any one of the above-mentioned items [1] to [4], the reflective layer is arranged on a part of one of the principal surfaces of the polarizing plate to define a reflective portion including the reflective layer and an exposed portion from which the polarizing plate is exposed, and the exposed portion functions as an absorption-axis direction check portion configured to enable checking of an absorption-axis direction of a polarizer of a viewer side polarizing plate of an image display apparatus.
[6] In any one of the above-mentioned items [1] to [5], the view blind check film further includes a transparent colored layer between the polarizing plate and the reflective layer.
[7] In any one of the above-mentioned items [1] to [6], the view blind check film has a total light reflectance of 20.0% or more.
[8] According to another aspect of the present invention, an image display apparatus is provided. The image display apparatus includes the view blind check film of any one of the above-mentioned items [1] to [7].
[9] According to another aspect of the present invention, a view blind check method is provided. The view blind check method includes: arranging the view blind check film of any one of the above-mentioned items [1] to [7] at a predetermined position on a display screen of an image display apparatus placed in a space viewable through a polarizing film; and checking whether or not a view blind function is effective for the image display apparatus based on brightness of the view blind check film viewed inside the space.
[10] In the above-mentioned item [9], the view blind check method includes: arranging the view blind check film of the above-mentioned item [5] at a predetermined position on a display screen of an image display apparatus placed in a space viewable through a polarizing film; checking the absorption-axis direction of the polarizer of the viewer side polarizing plate of the image display apparatus based on brightness of the exposed portion of the view blind check film viewed inside the space; and checking whether or not a view blind function is effective for the image display apparatus based on brightness of the reflective portion of the view blind check film viewed inside the space.

### BRIEF DESCRIPTION OF THE DRAWINGS

FIG. 1 is a schematic sectional view of a view blind check film according to one embodiment of the present invention.

FIG. 2 is a schematic sectional view of a view blind check film according to another embodiment of the present invention.

FIG. 3 is a schematic plan view of the view blind check film of FIG. 2.

FIG. 4 is a schematic sectional view of a view blind check film according to still another embodiment of the present invention.

FIGS. 5A and 5B are explanatory concept diagrams for illustrating a view blind check method according to one embodiment of the present invention.

### DESCRIPTION OF THE EMBODIMENTS

### Description of Embodiments

Typical embodiments of the present invention are described below. However, the present invention is not limited to these embodiments. For better visualization, the accompanying drawings are schematic. Thus, a thickness and a size of each of constituent elements of a view blind check film and a ratio of, for example, the thicknesses of the constituent elements in the drawings are different from actual values.

### A. View Blind Check Film

FIG. 1 is a schematic sectional view of a view blind check film according to one embodiment of the present invention. A view blind check film 100 of the illustrated example includes a polarizing plate 10 and a reflective layer 20. The reflective layer 20 is arranged entirely on one of principal surfaces of the polarizing plate 10. The polarizing plate 10 includes a polarizer and a protective layer arranged on at least one side of the polarizer. Specifically, the polarizing plate may be either a so-called one-side protected polarizing plate or a so-called double-side protected polarizing plate. The reflective layer may be a metal layer (typically, a mirror-finished metal layer), or may be a white layer. The reflective layer may be formed directly on the polarizing plate, or may be bonded to the polarizing plate via any appropriate adhesion layer (for example, an adhesive layer or a pressure-sensitive adhesive layer). Constituent elements of the view blind check film, such as the polarizing plate and the reflective layer, are specifically described later in the section C.

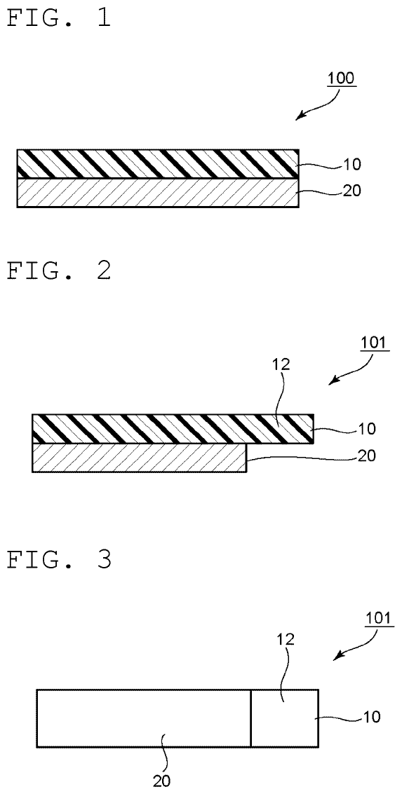

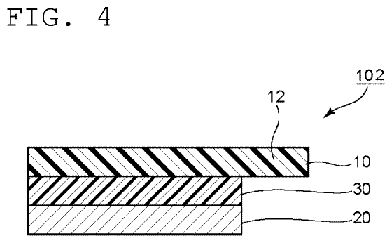

FIG. 2 is a schematic sectional view of a view blind check film according to another embodiment of the present invention. FIG. 3 is a schematic plan view of the view blind check film of FIG. 2 when viewed from a reflective layer side.

In a view blind check film 101 of the illustrated example, a reflective layer 20 is arranged on a part of one of principal surfaces of a polarizing plate 10. As a result, an exposed portion 12 from which the polarizing plate 10 is exposed is defined. A portion of the view blind check film 101, which includes the reflective layer 20, can be defined as a reflective portion. When the view blind check film is used for an image display apparatus in a space for which an anti-peeping system is employed, the exposed portion 12 functions as an absorption-axis direction check portion that enables checking of an adsorption-axis direction of a polarizer of a viewer side polarizing plate of the image display apparatus.

FIG. 4 is a schematic sectional view of a view blind check film according to still another embodiment of the present invention. A view blind check film 102 of the illustrated example further includes a transparent colored layer 30 between a polarizing plate 10 and a reflective layer 20. The transparent colored layer 30 may be provided at a position corresponding to a position at which the reflective layer 20 is arranged. Thus, in the view blind check film of FIG. 1, the transparent colored layer 30 may be provided entirely on one of principal surfaces of the polarizing plate 10.

A total light reflectance of the view blind check film is preferably 20.0% or more, more preferably 21.0% or more, still more preferably 24.0% or more, particularly preferably 27.0% or more, especially preferably 30.0% or more. Meanwhile, the total light reflectance of the view blind check film may be, for example, 35.0% or less, or may be, for example, 34.0% or less.

Now, a view blind check method is described below in the section B together with a mode of use and functions of the view blind check film. Subsequently, constituent elements (the polarizing plate, the reflective layer, and the transparent colored layer) of the view blind check film are described in the section C.

### B. View Blind Check Method

A view blind check method according to an embodiment of the present invention includes: arranging the view blind check film described in the above-mentioned section A at a predetermined position on a display screen of an image display apparatus placed in a space (space for which the anti-peeping system is employed) viewable through a polarizing film; and checking whether or not a view blind function is effective for the image display apparatus based on brightness of the view blind check film viewed inside the space.

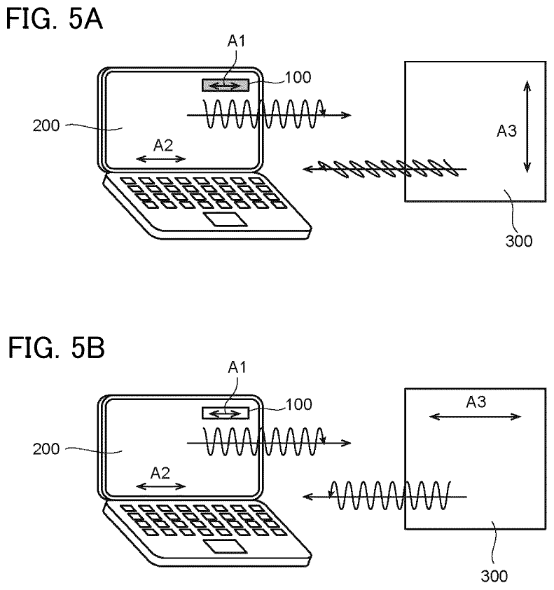

As illustrated in FIG. 5A and FIG. 5B, a laptop personal computer (PC) 200, which corresponds to the image display apparatus, is brought into a meeting room (space for which the anti-peeping system is employed) separated by a glass plate onto which a polarizing film 300 is bonded. Now, the view blind check method is described for the above-mentioned case as an example.

First, the view blind check film is arranged at a predetermined position on the laptop PC. The view blind check film may be bonded onto the laptop PC via an adhesion layer (for example, an adhesive layer or a pressure-sensitive adhesive layer), or may be first mounted to a holder and then be removably mounted to the laptop PC with any appropriate means (for example, a hook). The predetermined position is typically a position at which the view blind check film can be arranged without adversely affecting a display image and, at the same time, a position at which a viewer side polarizing plate of the laptop PC is present. Thus, the predetermined position is, for example, in the vicinity of a frame of the laptop PC. The view blind check film may be typically arranged so that the reflective layer is located on the image display apparatus side.

The view blind check film has a shape suitable for arrangement on the laptop PC. The view blind check film may typically have an elongated rectangular shape (for example, a strip-like shape). An absorption-axis direction of the polarizer included in the view blind check film may be either a longitudinal direction or a transverse direction.

For example, as illustrated in FIG. 5A and FIG. 5B, the view blind check film 100 having an elongated rectangular shape, which is illustrated in FIG. 1, may be arranged in the vicinity of a frame (in an upper right corner in the illustrated example) of the laptop PC 200 so as to extend in a horizontal direction. A display screen of the laptop PC 200 has a horizontally elongated shape, which is a typical shape of a display screen.

Now, description is given of a case in which an absorption-axis direction A2 of the polarizer of the viewer side polarizing plate of the laptop PC 200 is the horizontal direction and the view blind check film 100 is arranged on the laptop PC 200 so that an absorption-axis direction A1 of the polarizer of the view blind check film 100 matches the horizontal direction. As illustrated in FIG. 5A, when the absorption-axis direction A2 of the polarizer of the viewer side polarizing plate of the laptop PC 200 and an absorption-axis direction A3 of a polarizer of the polarizing film 300 are perpendicular to each other (specifically, the absorption-axis direction A3 of the polarizer of the polarizing film 300 is a vertical direction) and light emitted from a light source outside the space is defined as 100%, the light that has entered the space through the polarizing film 300 is absorbed by the polarizing film 300, and thus, is turned into polarized light of 45% or less, which oscillates in the horizontal direction. After being absorbed by the polarizing plate of the view blind check film 100, the polarized light is reduced to less than 1%. Thus, the view blind check film 100 looks dark when viewed by a viewer (user of the laptop PC) inside the space for which the anti-peeping system is employed. In this case, light (specifically, a display image) traveling from the laptop PC 200 is polarized light oscillating in the vertical direction. Thus, the light is absorbed by the polarizing film 300 and is not perceived from an outside of the space.

Meanwhile, as illustrated in FIG. 5B, when the absorption-axis direction A2 of the polarizer of the viewer side polarizing plate of the laptop PC 200 and the absorption-axis direction A3 of the polarizer of the polarizing film 300 are parallel to each other (specifically, the absorption-axis direction A3 of the polarizer of the polarizing film 300 is the horizontal direction) and light emitted from the light source outside the space is defined as 100%, the light that has entered the space for which the anti-peeping system is employed through the polarizing film 300 is turned into polarized light of 45% or less, which oscillates in the vertical direction. The polarized light is not absorbed by the polarizing plate of the view blind check film 100 but is reflected by the reflective layer of the view blind check film 100. As a result, the view blind check film 100 looks bright when viewed by the viewer (user of the laptop PC) inside the space. In this case, light traveling from the laptop PC 200 (specifically, a display image) is polarized light oscillating in the vertical direction. Thus, the light is not absorbed by the polarizing film 300 and is perceived from the outside of the space.

As is apparent from the description given above, with the arrangement in which the absorption-axis direction A1 of the polarizer of the view blind check film 100 and the absorption-axis direction A2 of the polarizer of the viewer side polarizing plate of the laptop PC 200 are parallel to each other, view blind is effective when the view blind check film 100 looks dark when viewed by the viewer (user of the laptop PC) inside the space for which the anti-peeping system is employed, and view blind is not effective when the view blind check film 100 looks bright when viewed by the viewer. Specifically, the viewer (user of the laptop PC) can check whether or not a view blind function of the anti-peeping system is effective for the laptop PC corresponding to the image display apparatus based on brightness of the view blind check film viewed inside the space for which the anti-peeping system is employed. In other words, the user of the laptop PC can check whether or not the laptop PC is blinded without exiting the space (for example, a meeting room) for which the anti-peeping system is employed.

Further, as is apparent from the description given above, it is preferred that whether or not the absorption-axis direction of the polarizer of the view blind check film and the absorption-axis direction of the polarizer of the viewer side polarizing plate of the laptop PC are parallel to each other be checked. The use of the view blind check film 101 as illustrated in FIG. 2, which has the exposed portion defined for the polarizing plate, allows the above-mentioned check to easily be performed. For example, when the view blind check film has the exposed portion and polarized light in the vertical direction from the laptop PC is defined as 100% under conditions illustrated in FIG. 5A, an absorption-axis direction of the exposed portion is parallel to the absorption-axis direction of the polarizer of the viewer side polarizing plate of the laptop PC. Thus, the polarized light in the vertical direction from the laptop PC is not absorbed, and the exposed portion remains looking bright. In this case, the user of the laptop PC can check whether or not the laptop PC is blinded without changing the arrangement of the view blind check film. Meanwhile, when the polarized light in the vertical direction from the laptop PC is defined as 100% and the absorption-axis direction of the polarizer of the view blind check film and the absorption-axis direction of the polarizer of the viewer side polarizing plate of the laptop PC are, for example, perpendicular to each other, the exposed portion absorbs the polarized light in the vertical direction from the laptop PC and the polarized light is reduced to 1% or less. Thus, the exposed portion looks dark. In this case, the absorption-axis direction of the polarizer of the view blind check film and the absorption-axis direction of the polarizer of the viewer side polarizing plate of the laptop PC can be made parallel to each other by changing the arrangement of the view blind check film. For example, when the absorption-axis direction is the transverse direction of the view blind check film and the view blind check film is arranged in the horizontal direction as illustrated in FIG. 5A, the exposed portion looks dark. In this case, when the view blind check film is arranged in the vertical direction, the absorption-axis direction of the polarizer of the view blind check film and the absorption-axis direction of the polarizer of the viewer side polarizing plate of the laptop PC can be made parallel to each other. As a result, the user of the laptop PC can check in the same manner as that described above whether or not the laptop PC is blinded. As described above, when the view blind check film having the exposed portion is used, the absorption-axis direction of the polarizer of the viewer side polarizing plate of the laptop PC can be checked based on brightness of the exposed portion.

When the view blind check film includes the transparent colored layer, visibility of the view blind check film can be improved in the space for which the anti-peeping system is employed. A color of the transparent colored layer can be appropriately set in accordance with its purpose of use. Examples of the color of the transparent colored layer include red, blue, green, and yellow.

As described above, a viewer of the image display apparatus can check whether or not the view blind function of the anti-peeping system is effective for the image display apparatus without exiting the space for which the anti-peeping system is employed. Specifically, the image display apparatus including the view blind check film according to the embodiment of the present invention enables simple and satisfactory checking of whether or not the laptop PC is blinded inside the space for which the anti-peeping system is employed. Thus, the image display apparatus as described above can be encompassed in the embodiment of the present invention.

### C. Constituent Elements of View Blind Check Film

### C-1. Polarizing Plate

### C-1-1. Polarizer

Any appropriate polarizer may be adopted as a polarizer. The polarizer is typically formed of a polyvinyl alcohol (PVA)-based resin film containing a dichroic substance (e.g., iodine). Examples of the PVA-based resin include polyvinyl alcohol, a partially formalized polyvinyl alcohol, an ethylene-vinyl alcohol copolymer, and an ethylene-vinyl acetate copolymer-based partially saponified product. For example, the resin film for forming the polarizer may be a single-layer resin film or may be a laminate of two or more layers.

Specific examples of the polarizer formed of a single-layer resin film include hydrophilic polymer films, such as a PVA-based film, a partially formalized PVA-based film, and an ethylene-vinyl acetate copolymer-based partially saponified film, which have been subjected to dyeing treatment with a dichroic substance, such as iodine or a dichroic dye, and stretching treatment, and a polyene-based alignment film, such as a dehydrated product of PVA or a dehydrochlorinated product of polyvinyl chloride. A polarizer obtained by subjecting a PVA-based film to dyeing with iodine and uniaxial stretching is preferably used because such polarizer is excellent in optical characteristics.

The dyeing with iodine is performed by, for example, immersing the PVA-based film in an aqueous solution of iodine. The stretching ratio of the uniaxial stretching is preferably from 3 times to 7 times. The stretching may be performed after the dyeing treatment, or may be performed while the dyeing is performed. In addition, the dyeing may be performed after the stretching. As required, the PVA-based film is subjected to swelling treatment, cross-linking treatment, washing treatment, drying treatment, and the like. For example, when the PVA-based film is washed with water by being immersed in water before the dyeing, not only contamination and an anti-blocking agent on the surface of the PVA-based film can be washed off, but also the PVA-based film can be swollen to prevent dyeing unevenness and the like.

A specific example of the polarizer obtained by using the laminate is a polarizer obtained by using a laminate of a resin substrate and a PVA-based resin layer (PVA-based resin film) laminated on the resin substrate or a laminate of a resin substrate and a PVA-based resin layer formed on the resin substrate through application. The polarizer obtained by using the laminate of the resin substrate and the PVA-based resin layer formed on the resin substrate through application may be produced, for example, by: applying a PVA-based resin solution to the resin substrate; drying the solution to form the PVA-based resin layer on the resin substrate, to thereby provide the laminate of the resin substrate and the PVA-based resin layer; and stretching and dyeing the laminate to turn the PVA-based resin layer into the polarizer. In this embodiment, a polyvinyl alcohol-based resin layer containing a halide and a polyvinyl alcohol-based resin is preferably formed on one side of the resin substrate. The stretching typically includes stretching the laminate under a state in which the laminate is immersed in an aqueous solution of boric acid. Further, the stretching may further include in-air stretching of the laminate at high temperature (e.g., 95° C. or more) before the stretching in the aqueous solution of boric acid as required. In addition, in this embodiment, the laminate is preferably subjected to drying shrinkage treatment, which includes heating the laminate, while conveying the laminate in a lengthwise direction thereof, to shrink the laminate by 2% or more in a widthwise direction thereof. The production method of this embodiment typically includes subjecting the laminate to in-air auxiliary stretching treatment, dyeing treatment, underwater stretching treatment, and drying shrinkage treatment in the stated order. When the auxiliary stretching is introduced, even in the case where PVA is applied onto a thermoplastic resin, the crystallinity of PVA can be improved, and hence high optical characteristics can be achieved. In addition, when the alignment property of PVA is improved in advance simultaneously with the crystallinity improvement, problems, such as a reduction in alignment property of PVA and the dissolution thereof, can be prevented at the time of the immersion of the laminate in water in the subsequent dyeing step or stretching step, and hence high optical characteristics can be achieved. Further, in the case where the PVA-based resin layer is immersed in a liquid, the disturbance of the alignment of the molecules of polyvinyl alcohol and reductions in alignment properties thereof can be suppressed as compared to those in the case where the PVA-based resin layer is free of any halide. Thus, the optical characteristics of the polarizer to be obtained through treatment steps performed by immersing the laminate in a liquid, such as the dyeing treatment and the underwater stretching treatment, can be improved. Further, the optical characteristics can be improved by shrinking the laminate in its widthwise direction through the drying shrinkage treatment. The resultant laminate of the resin substrate and the polarizer may be used as it is (that is, the resin substrate may be used as a protective layer for the polarizer), or may be used by laminating any appropriate protective layer in accordance with purposes on the peeled surface on which the resin substrate has been peeled from the laminate of the resin substrate and the polarizer, or on a surface on an opposite side to the peeled surface. Details about such method of producing the polarizer are described in, for example, JP 2012-73580 A and JP 6470455 B1, the descriptions of which are incorporated herein by reference in their entirety.

The thickness of the polarizer is, for example, 12 μm or less, preferably 10 μm or less, more preferably from 1 μm to 8 μm, still more preferably from 3 μm to 7 μm. A combination of such a thin polarizer and a liquid crystal alignment fixed layer allows the view blind check film to be significantly thinned. Further, when the thickness of the polarizer falls within the ranges as described above, the curling thereof at the time of its heating can be satisfactorily suppressed, and satisfactory appearance durability thereof at the time of the heating can be obtained.

The polarizer preferably shows absorption dichroism at a certain wavelength in the wavelength range of from 380 nm to 780 nm. The single layer transmittance of the polarizer is preferably from 41.0% to 46.0%, more preferably from 42.0% to 45.0%. The polarization degree of the polarizer is preferably 97.0% or more, preferably 99.0% or more, still more preferably 99.9% or more.

### C-1-2. Protective Layer

The protective layer is formed of any appropriate resin film. A material for forming the resin film is typically a cellulose-based resin such as triacetylcellulose (TAC), a cycloolefin-based resin such as polynorbornene, a (meth) acrylic resin, a polyester-based resin, such as polyethylene terephthalate (PET) or polyethylene naphthalate (PEN), a polyolefin-based resin such as polyethylene, or a polycarbonate-based resin. A typical example of the (meth) acrylic resin is a (meth) acrylic resin having a lactone ring structure. The (meth) acrylic resin having a lactone ring structure is described in, for example, JP 2000-230016 A, JP 2001-151814 A, JP 2002-120326 A, JP 2002-254544 A, and JP 2005-146084 A, which are incorporated herein by reference.

The thickness of the protective layer is preferably from 10 μm to 80 μm, more preferably from 12 μm to 40 μm, still more preferably from 15 μm to 35 μm.

### C-2. Reflective Layer

A total light reflectance of the reflective layer is preferably 80.0% or more, more preferably 85.0% or more, still more preferably 90.0% or more. When the total light reflectance falls within the above-mentioned ranges, whether the view blind check film looks bright or dark can be suitably checked so as to check inside the space for which the anti-peeping system is employed whether or not the view blind function is effective for the image display apparatus. It is preferred that the total light reflectance be as high as possible. An upper limit of the total light reflectance may be, for example, 99.0%, or may be, for example, 98.0%.

Any appropriate structure may be adopted for the reflective layer as long as effects of the embodiment of the present invention can be obtained. Specifically, the reflective layer may be a metal layer (typically, a mirror-finished metal layer), or may be a white layer.

The metal layer may be a layer formed through a dry process, or may be a metal foil. Specific examples of the dry process include a physical vapor deposition (PVD) method and a chemical vapor deposition (CVD) method. Examples of the PVD method include a vacuum vapor deposition method, a reactive vapor deposition method, an ion beam assisted deposition method, a sputtering method, and an ion plating method. An example of the CVD method is a plasma CVD method. Specific examples of a metal for forming the metal layer include aluminum, gold, silver, copper, and platinum. In one embodiment, the metal layer is an aluminum vapor-deposited layer.

A total light reflectance of the metal layer is preferably 80.0% or more, more preferably 85.0% or more, still more preferably 90.0% or more. It is preferred that the total light reflectance be as high as possible. An upper limit of the total light reflectance may be, for example, 99.0%, or may be, for example, 98.0%. All reflection by the metal layer is substantially specular reflection. Thus, a total light reflectance of the metal layer is substantially a specular reflectance.

A thickness of the metal layer formed through a dry process is preferably from 10 nm to 150 nm, more preferably from 20 nm to 100 nm. A thickness of the metal layer formed of a metal foil is preferably from 1 μm to 200 μm, more preferably from 10 μm to 100 μm.

The white layer may typically be formed of a porous white reflective film or a white reflective film containing microparticles, such as titanium oxide or silica microparticles, dispersed in a matrix resin. A thermoplastic resin film containing air bubbles and/or immiscible particles may be suitably used as the porous white reflective film. Typical examples of a resin for forming the film include a polyolefin (e.g., polypropylene) and a polyester (e.g., polyethylene terephthalate or an aliphatic polyester). A polyester is preferred, and polyethylene terephthalate is more preferred, because of excellent formability, mechanical strength, and versatility. The porous white reflective film may be an unstretched film, a uniaxially stretched film, or a biaxially stretched film. Detailed configurations of the porous white reflective film are described in, for example, JP 08-262208 A, JP 2002-090515 A, and JP 5218931 B2, the descriptions of which are incorporated herein by reference in their entirety.

A total light reflectance of the white layer is preferably 80.0% or more, more preferably 85.0% or more, still more preferably 90.0% or more. It is preferred that the total light reflectance be as high as possible. An upper limit of the total light reflectance may be, for example, 99.0%, or may be, for example, 98.0%. Most of the reflection by the white layer is diffuse reflection. A diffuse reflectance of the white layer may be, for example, from 80.0% to 93.0%, or may be, for example, from 85.0% to 92.0%.

The thickness of the white layer is preferably from 10 μm to 300 μm, more preferably from 50 μm to 200 μm.

A commercially available white reflective film may be used as the white layer. Specific examples of such commercially available product include: products available under the product names “Lumirror E6SR” and “Lumirror E20” from Toray Industries, Inc.; a product available under the product name “DIAFOIL W400-50” from Mitsubishi Chemical Corporation; a product available under the product name “REF-WHITE” from KIMOTO Co., Ltd; and a printing sheet (white) for a printer.

### C-3. Transparent Colored Layer

As described above, when the view blind check film includes the transparent colored layer, the visibility of the view blind check film in the space for which the anti-peeping system is employed can be improved. Any appropriate structure may be adopted for the transparent colored layer as long as the visibility improvement effect can be obtained. Typical examples of the transparent colored layer include a transparent resin film containing any appropriate coloring material and a transparent adhesive containing any appropriate coloring material. Examples of a resin for forming the transparent resin film include a polyester (e.g., polyethylene terephthalate, polybutylene terephthalate, or an aliphatic polyester), polyethylene, polypropylene, polyvinyl chloride, and polycarbonate. Examples of a base polymer for forming the transparent adhesive include an acrylic resin, an amide-imide-based resin, a urethan-based resin, an epoxy-based resin, a phenol-based resin, a vinyl acetate-based resin, an ethylene-vinyl acetate copolymer-based resin, a styrene-butadiene rubber-based resin, a vinyl chloride-based resin, a chloroprene rubber-based resin, a nitrile rubber-based resin, a reclaimed rubber-based resin, and a silicone-based resin.

The coloring material can appropriately be selected in accordance with a desired color for the transparent colored layer. The coloring material may be an organic coloring material, or may be an inorganic coloring material. A typical example of the organic coloring material is a dye. Examples of the dye include a phthalocyanine-based dye, a quinophthalone-based dye, a dioxazine-based dye, a quinacridone-based dye, and an isoindolinone-based dye. A typical example of the inorganic coloring material is a pigment. Examples of the pigment include yellow lead, yellow iron oxide, red iron oxide, titanium dioxide, and carbon black. The coloring materials may be used alone or in combination thereof.

As described above, a color of the transparent colored layer may be appropriately set in accordance with its purpose of use. Examples of the color of the transparent colored layer include red, blue, green, and yellow.

The thickness of the transparent colored layer is preferably from 1 μm to 50 μm, more preferably from 5 μm to 30 μm.

A commercially available product may be used as a laminate of the reflective layer and the transparent colored layer. For example, an aluminum vapor-deposited colored transparent polyester film is commercially available. An example of the commercially available product is a product available under the product name “LIVIC Tape” from Nitto Denko Corporation.

### EXAMPLES

The present invention is specifically described below by way of Examples. However, the present invention is not limited to these Examples.

### Example 1

### 1. Production of Polarizing Plate

### 1-1. Production of Polarizer

An amorphous isophthalic acid-copolymerized polyethylene terephthalate film (thickness: 100 μm) having an elongate shape, and a Tg of about 75° C. was used as a thermoplastic resin substrate, and one surface of the resin substrate was subjected to corona treatment.

A product obtained by adding 13 parts by weight of potassium iodide to 100 parts by weight of a PVA-based resin, which had been obtained by mixing polyvinyl alcohol (polymerization degree: 4,200, saponification degree: 99.2 mol %) and acetoacetyl-modified PVA (manufactured by the Nippon Synthetic Chemical Industry Co., Ltd., product name: “Gohsefimer”) at 9:1, was dissolved in water to prepare a PVA aqueous solution (application liquid).

The PVA aqueous solution was applied to the corona-treated surface of the resin substrate, and was dried at 60° C. to form a PVA-based resin layer having a thickness of 13 μm. Thus, a laminate was produced.

The resultant laminate was subjected to uniaxial stretching in its longitudinal direction (lengthwise direction) at a ratio of 2.4 times in an oven at 130° C. (in-air auxiliary stretching treatment).

Next, the laminate was immersed in an insolubilizing bath having a liquid temperature of 40° C. (aqueous solution of boric acid obtained by blending 100 parts by weight of water with 4 parts by weight of boric acid) for 30 seconds (insolubilizing treatment).

Next, the laminate was immersed in a dyeing bath having a liquid temperature of 30° C. (aqueous solution of iodine obtained by blending 100 parts by weight of water with iodine and potassium iodide at a weight ratio of 1:7) for 60 seconds while the concentration of the aqueous solution was adjusted so that the single layer transmittance (Ts) of a polarizer to be finally obtained became a desired value (dyeing treatment).

Next, the laminate was immersed in a cross-linking bath having a liquid temperature of 40° C. (aqueous solution of boric acid obtained by blending 100 parts by weight of water with 3 parts by weight of potassium iodide and 5 parts by weight of boric acid) for 30 seconds (cross-linking treatment).

After that, while the laminate was immersed in an aqueous solution of boric acid having a liquid temperature of 70° C. (boric acid concentration: 4 wt %, potassium iodide concentration: 5 wt %), the laminate was subjected to uniaxial stretching in the longitudinal direction (lengthwise direction) between rolls having different peripheral speeds so that the total stretching ratio became 5.5 times (underwater stretching treatment).

After that, the laminate was immersed in a washing bath having a liquid temperature of 20° C. (aqueous solution obtained by blending 100 parts by weight of water with 4 parts by weight of potassium iodide) (washing treatment).

After that, the laminate was brought into contact with a SUS-made heating roll whose surface temperature was kept at about 75° C. while being dried in an oven kept at about 90° C. (drying shrinkage treatment).

Thus, a polarizer having a thickness of about 5 μm was formed on the resin substrate to thereby form a polarizing plate having the configuration of “resin substrate/polarizer.” A single layer transmittance Ts of the polarizer was 42.2%.

### 1-2. Production of Polarizing Plate

A triacetylcellulose (TAC) film (with a thickness of 25 μm) was bonded to a surface (opposite to the resin substrate) of the resultant polarizer. Subsequently, after the resin substrate was peeled from the polarizer, a TAC film, which was the same as the TAC film described above, was bonded to the peeled surface. Thus, a polarizing plate having the configuration of “TAC film (protective layer)/polarizer/TAC film (protective layer)” was obtained.

### 2. Production of View Blind Check Film

The thus obtained polarizing plate was cut out into a strip shape of 10 mm×50 mm. At this time, the polarizing plate was cut out so that an absorption-axis direction of the polarizer matched a lengthwise direction (longitudinal direction). An adhesion tape including a substrate being an aluminum vapor-deposited polyester film serving as a reflective layer (metal layer) was bonded entirely to one of principal surfaces of the cut-out polarizing plate via an acrylic pressure-sensitive adhesive to thereby form the view blind check film illustrated in FIG. 1. A total light reflectance of the metal tape was 95.1%, a specular reflectance thereof was 95.1%, and a total light reflectance of the view blind check film was 30.4%.

### 3. View Blind Check

A polarizing film (common polarizing plate) was bonded to a partition of a glass plate so that an absorption axis of the polarizer matched the vertical direction. Then, a commercially available laptop PC was placed in a space that was viewable through the partition. Subsequently, the view blind check film obtained as described above was bonded in the vicinity of a frame (in an upper right corner) of the laptop PC so as to extend in the horizontal direction. When the laptop PC was viewed through the partition, a display image looked dark. Thus, it was successfully confirmed from an outside of the space that view blind was effective. Further, when the laptop PC was viewed directly inside the space, the view blind check film looked dark. Thus, it was successfully confirmed inside the space that view blind was effective. However, it was impossible to check an absorption-axis direction of a polarizer of a viewer side polarizing plate of the laptop PC. The results are summarized and shown in Table 1.

### Example 2

A view blind check film as illustrated in FIG. 2 was obtained in the same manner as that in Example 1 except that an adhesion tape was bonded to a part of one of principal surfaces of a polarizing plate to define an exposed portion for the polarizing plate. Whether or not the laptop PC was blinded was checked in the same manner as that in Example 1 except that the view blind check film obtained as described above was used. As a result, it was successfully confirmed both from the outside of the space and inside the space that view blind was effective. Further, when the laptop PC was viewed directly without the partition, the exposed portion of the view blind check film looked bright. Thus, it was successfully confirmed that an absorption-axis direction of a polarizer of a viewer side polarizing plate of the laptop PC was the horizontal direction (specifically, an absorption-axis direction of the view blind check film and the absorption-axis direction of the polarizer of the viewer side polarizing plate of the laptop PC were parallel to each other). The results are summarized and shown in Table 1.

### Example 3

A view blind check film as illustrated in FIG. 2 was obtained in the same manner as that in Example 2 except that a white reflective film (manufactured by Toray Industries, Inc., product name: “Lumirror E6SR”) was used in place of the adhesion tape. A total light reflectance of the white reflective film was 96.6%, a specular reflectance thereof was 5.1%, and a total light reflectance of the view blind check film was 21.9%.

Whether or not the laptop PC was blinded was checked in the same manner as that in Example 1 except that the view blind check film obtained as described above was used. As a result, it was successfully confirmed both from the outside of the space and inside the space that view blind was effective. Further, when the laptop PC was viewed directly without the partition, the exposed portion of the view blind check film looked bright. Thus, it was successfully confirmed that an absorption-axis direction of a polarizer of a viewer side polarizing plate of the laptop PC was the horizontal direction (specifically, an absorption-axis direction of the view blind check film and the absorption-axis direction of the polarizer of the viewer side polarizing plate of the laptop PC were parallel to each other). The results are summarized and shown in Table 1.

### Comparative Example 1

Whether or not the laptop PC was blinded was checked in the same manner as that in Example 1 except that the view blind check film was not bonded to the laptop PC. As a result, it was not confirmed inside the space whether or not view blind was effective. The results are summarized and shown in Table 1.

### Comparative Example

The polarizing plate that was cut out in Example 1 was used. Specifically, whether or not the laptop PC was blinded was checked in the same manner as that in Example 1 except that the reflective layer was not formed. As a result, it was not confirmed inside the space whether or not view blind was effective. The results are summarized and shown in Table 1.

TABLE 1

| | | | | Absorption- | |
|---|---|---|---|---|---|
| | Reflective | Exposed | Inside | axis | Outside |
| | layer | portion | space | direction | space |
| Example 1 | Metal | Absent | Possible | Impossible | Possible |
| | layer | | | | |
| Example 2 | Metal | Present | Possible | Possible | Possible |
| | layer | | | | |
| Example 3 | White | Present | Possible | Possible | Possible |
| | layer | | | | |
| Comparative | None | Absent | Impossible | Impossible | Possible |
| Example 1 | | | | | |
| Comparative | None | Present | Impossible | Possible | Possible |
| Example 2 | | | | | |

*A common polarizing plate was used in Comparative Example 2. Thus, the entire polarizing plate was treated as an exposed portion.
* In the column ″Inside space,″ it is indicated whether or not it was possible to check inside the space for which the anti-peeping system was employed whether or not the laptop PC was blinded.
*In the column ″Absorption-axis direction,″ it is indicated whether or not it was possible to check the absorption-axis direction of the polarizer of the viewer side polarizing plate of the laptop PC.
*In the column ″Outside space, ″ it is indicated whether or not it was possible to check from an outside of the space for which the anti-peeping system was employed whether or not the laptop PC was blinded.

According to Examples of the present invention, the use of the view blind check film allows whether or not the image display apparatus is blinded to be checked inside the space for which the anti-peeping system is employed.

The view blind check film according to the embodiments of the present invention can be suitably used to check inside the space for which the anti-peeping system is employed whether or not the image display apparatus is blinded.

According to the at least one embodiment of the present invention, it is possible to achieve the view blind check film that allows whether or not the image display apparatus is blinded to easily be checked inside a space for which an anti-peeping system is employed.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A view blind check film, comprising:
a polarizing plate including a polarizer; and
a reflective layer arranged on at least a part of one of principal surfaces of the polarizing plate.

2. The view blind check film according to claim 1, wherein the reflective layer has a total light reflectance of 80.0% or more.

3. The view blind check film according to claim 2, wherein the reflective layer is a metal layer.

4. The view blind check film according to claim 2, wherein the reflective layer is a white layer.

5. The view blind check film according to claim 1,
wherein the reflective layer is arranged on a part of one of the principal surfaces of the polarizing plate to define a reflective portion including the reflective layer and an exposed portion from which the polarizing plate is exposed, and
wherein the exposed portion functions as an absorption-axis direction check portion configured to enable checking of an absorption-axis direction of a polarizer of a viewer side polarizing plate of an image display apparatus.

6. The view blind check film according to claim 1, further comprising a transparent colored layer between the polarizing plate and the reflective layer.

7. The view blind check film according to claim 1, wherein the view blind check film has a total light reflectance of 20.0% or more.

8. An image display apparatus, comprising the view blind check film of claim 1.

9. A view blind check method, comprising:
arranging the view blind check film of claim 1 at a predetermined position on a display screen of an image display apparatus placed in a space viewable through a polarizing film; and
checking whether or not a view blind function is effective for the image display apparatus based on brightness of the view blind check film viewed inside the space.

10. A view blind check method, comprising:
arranging the view blind check film of claim 5 at a predetermined position on a display screen of an image display apparatus placed in a space viewable through a polarizing film;
checking the absorption-axis direction of the polarizer of the viewer side polarizing plate of the image display apparatus based on brightness of the exposed portion of the view blind check film viewed inside the space; and
checking whether or not a view blind function is effective for the image display apparatus based on brightness of the reflective portion of the view blind check film viewed inside the space.
